(19) United States
(12) Patent Application Publication
(10) Pub. No.: US 2017/0250033 A1
(43) Pub. Date: Aug. 31, 2017

(54) A method for making a high-density carbon material for high-density carbon electrodes

(71) Applicant: OÜ Skeleton Technologies Group, Tallinn (EE)

(72) Inventors: Anti Perkson, Nõo (EE); Mati Arulepp, Tartu (EE); Jaan Leis, Tartu (EE)

(73) Assignee: OÜ Skeleton Technologies Group, Tallinn (EE)

(21) Appl. No.: 15/523,391

(22) PCT Filed: Nov. 2, 2015
(86) PCT No.: PCT/EP2015/075495

§ 371 Date: Apr. 30, 2017

Related U.S. Application Data
(60) Provisional application No. 62/073,090, filed on Oct. 31, 2014.

(51) Int. Cl. H01G 11/34; H01G 11/42; H01G 11/86; H01G 11/26

(52) U.S. Cl. CPC H01G 11/34; H01G 11/26; H01G 11/42; H01G 11/86

(57) ABSTRACT

The present invention is related with a method for making a high-density carbon material for high-density carbon electrodes by wet process free of organic solvents comprising the steps of pre-compaction of carbon/polymer composite in wet process, making a dry precursor from pre-compacted carbon/polymer composite in the form of slurry by evaporating aqueous solution from said carbon-polymer composite slurry and milling in non-destructive way a blended dry precursor thereafter into a carbon-polymer composite granulated powder and thereafter forming a carbon-polymer composite film from said carbon-polymer composite granulated powder.

This Application is related to and claims priority from commonly assigned U.S. Provisional Application Ser. No. 62/073,090, filed 31 Oct. 2014 which is incorporated herein by reference.

### TECHNICAL FIELD

This invention relates in general to the field of carbon-based energy storage. More particularly, this invention relates to an ultracapacitor with at least one electrical double-layer carbon electrode. This invention also relates to the improvements in the method of making high-density carbon electrodes.

### BACKGROUND ART

Carbon electrodes are widely used for the energy storage, for example, in electrical double layer (EDL) capacitors. The EDL capacitors, also called as ultracapacitors or supercapacitors, are made of the high-surface carbon electrodes attached to metallic current collectors and interleaved by the porous separator sheet. The separator is usually polymeric film—such as polyethylene, polypropylene, cellulose-based paper etc. or any porous nonconductive material. Typical ultracapacitor is described in U.S. Pat. No. 6,602,742. EDL carbon electrode may also be coupled to electrochemical battery electrode, to produce a so-called hybrid capacitor.

Porous carbon electrodes store the energy via physical adsorption of electrolyte ions. Therefore, the larger carbon surface area, the more energy may be stored in carbon electrode. On the other hand, the better the surface area is packed, the smaller the energy storage device can be built, which is a crucial issue for many energy storage applications. One goal of this invention is to provide carbon electrode with high packing density.

Carbon electrodes are attached to the metal, usually aluminium foil, current collector by coating, gluing or laminating. Direct coating of carbon layer onto current collector, however, yields rather low compaction of carbon particles, and is therefore not favoured for high energy density storage devices. Carbon electrodes, made by roll-pressing technique and thereafter attached to the current collector, are advantageous when the higher energy density of the electrodes is a goal.

Prior art (WO2006/135495) teaches how to make the roll-pressed carbon film from dry mixture of active carbon and polymeric binder. The drawback of completely solvent-free technology is that the dry mixture is almost impossible to compact to reach high packing density of carbon particles. Dry compaction requires high forces in calendaring that leads to the partial cracking or crushing the carbon particles, which reduces the mechanical strength and electrical conductivity of resulted carbon electrodes. Compacting of carbon particles from wet slurry is easier and less destructive.

Document US2006143884 (A1), 6.07.2006 (Maxwell Technologies, Inc) discloses a method of manufacturing an electrode. According to the method, a current collector and a film of active electrode material are provided and stacked so that a first surface of the current collector is in contact with the film. The resulting stack is then laminated by pressing the current collector and the film to cause the film to densify and to adhere to the first surface of the current collector, thereby obtaining a laminated electrode product. Lamination is performed so that the film is densified without spreading to an extent necessitating trimming.

Document US20050271798 (A1), Aug. 12, 2005 (Maxwell Technologies, Inc.) describes a method for electrode fabrication techniques with a reduced number of process steps. According to this method, fibrillized particles of active electrode material are deposited on a first surface of a current collector sheet. The current collector sheet and the fibrillized particles are then calendered to obtain a first active electrode material film bonded to the first surface of the current collector sheet. The fibrillized particles deposited on the first surface are made using a dry process, such as dry-blending and dry fibrillization techniques.

Prior art also teaches how to make the roll-pressed carbon sheets from wet slurry of the active carbon and polymeric binder, wherein the organic solvents are used for making the slurry (U.S. Pat. No. 6,602,742; WO2011/135451). Solvent helps to disperse the binder material between carbon particles and also aids in compacting of the particles during roll-pressing into carbon sheet. When using the carbon particles with high content of micropores (by IUPAC definition pores with a diameter below 2 nm), the drawback of organic solvents is that the solvent molecules are trapped in small pores and are therefore difficult to remove from the carbon electrodes before immersion with the electrolyte. The traces of undesired solvent in the electrode, on the other hand, may significantly decrease the life of the storage device. Due to the need to recover or burn off the evaporated organic solvents, the drying process is expensive and increases the production cost of the storage device.

The goal of this invention thus is to eliminate the organic solvents from the carbon electrode making process. At the same time the present invention differs from the prior art because the purpose of the invention is technology which ensures high density packing of carbon material and good coherence of the carbon particles in the carbon electrode. Said characteristics will ensure high energy density of the carbon electrode, good electrical conductivity and long lifetime of the electrode during electrochemical cycling.

### DISCLOSURE OF INVENTION

This invention comprises a method for making a porous conductive film for use in an energy storing electrode. The method combines the sequential steps of:

1. pre-compaction of carbon/polymer composite in wet process;

2. making the dry precursor for carbon/polymer film;

3. formation of carbon/polymer film by compressing treatment.

According to this invention the pre-compaction is needed for formation of the agglomerates of carbon particles bound together by polymer chains. Pre-compaction is carried out in creamy carbon-polymer slurry, which is wetted by aqueous solution for example water-based liquid or water (distilled water). In various methods described in prior art for making the EDL carbon electrode film the water usage has been avoided to reduce the possibility of trapping water in micropores, which would be difficult to dry out before filling with the electrolyte. The incomplete removal of water, however, would seriously damage the organic electrolyte based ultracapacitor. Novelty of this invention is that water supports the dispersion of non-soluble polymeric binder, such as polymeric fluoroalkyl (for example polytetrafluoroethylene—PTFE) in carbon slurry. Furthermore, according to this invention, the water is easily evaporated from the slurry, because the hydrophobic surface of microporous carbon, used for making slurry, prevents the water penetration in nanopores. Precompaction comprises following procedures in a sequence (FIG. 1):
1. applying an aqueous solution free of organic solvents to the carbon powder, such that the carbon and an aqueous solution liquid form a creamy carbon slurry;
2. dispersing a non-soluble polymeric binder such as polymeric fluoroalkyl compound in the creamy carbon slurry to form homogeneous slurry of carbon-polymer composite;
3. evaporating aqueous solution from the carbon-polymer composite,
4. milling non destructively a dried carbon-polymer composite thereafter into the granules,

According to another approach, the pre-compaction may additionally include the treatment of premixed components of the carbon electrode in the high-shear compounder (FIG. 2). The sequence of the procedures for making the pre-compacted electrode material, which leads to the superior high-density carbon electrode and, therefore, is an essential part of this invention:

1. Wet premixing of porous carbon, optional conductive additive and binder chosen from fluoropolymers, butyl rubbers or so-called 3D-binders such as carboxymethyl cellulose (CMC);

2. Evaporating aqueous solution from the premixed carbon-polymer composite;

3. The high-shear compounding, which provides good distribution of the electrode material components (e.g., microporous carbon, carbon black and fluropolymer) in the electrode material, at the same time it provides good packing of the carbon particles (to the maximum theoretical compactness) and further improvement of 3D net formation between fluorocarbon binder and the carbon particles through shear action between compounder mixing blade and mixing chamber walls. The high shear compounder can be used in a batch as well as in a continuous mode

High-shear compounder can be any mixing extruding machine which provides shear action between mixing blade and mixing chamber walls

4. Granulation of resulting material to the size of 10-1000 mkm, depending on final electrode thickness required. Each individual granule retains the pre-compacted material density—hence less force is required for calendering process.

After that, the granules of pre-compacted carbon-polymer composite are compressed, e.g. by rolling, into a porous conductive film. Another approach is to deposit the granules electrostatically or by other means on the surface of current collector (such as metal foil, e.g., aluminium, titanium or cupper) being thereafter calendered to achieve good electrical contact between carbon and current collector.

### BRIEF DESCRIPTION OF DRAWINGS

FIG. 1. General sequence of procedures applied for the pre-compaction of the electrode material prior electrode formation.

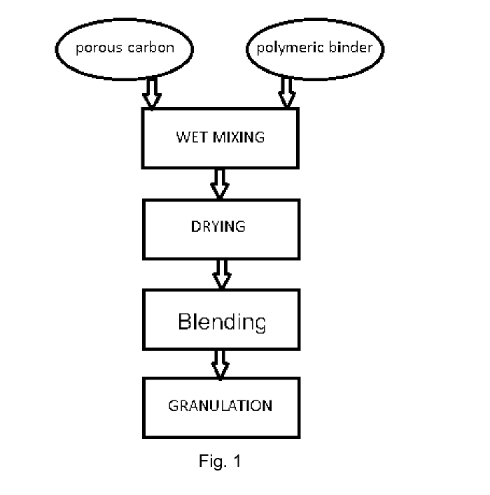

FIG. 2. General sequence of procedures, including high-shear treatment, applied for the pre-compaction of the electrode material prior electrode formation.

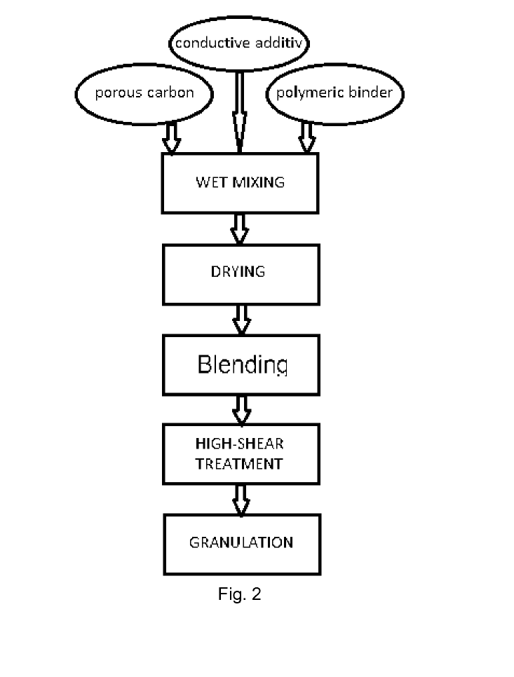

### BEST MODE FOR CARRYING OUT THE INVENTION

According to the present invention a method for making a high-density carbon material for high-density carbon electrodes by wet process free of organic solvents comprising the steps of:

a) pre-compaction of carbon/polymer composite in wet process where ii) applying an aqueous solution free of organic solvents to the carbon powder to form a creamy slurry of the carbon powder and an aqueous solution in which the nanopores of carbon powder are not penetrated by aqueous solution,

ii) dispersing a non-soluble polymeric binding material into the creamy slurry of the carbon powder and the aqueous solution to form homogeneous mixture of carbon-polymer composite in the form of slurry;

b) making a dry precursor from pre-compacted carbon/polymer composite in the form of slurry by evaporating aqueous solution from said carbon-polymer composite slurry,

c) milling in non-destructive way a blended dry precursor thereafter into a carbon-polymer composite granulated powder and thereafter forming a carbon-polymer composite film from said carbon-polymer composite granulated powder.

Before forming the creamy slurry of the carbon powder and the aqueous solution in step a) i) an ionic compound as a component of electrolyte is added to the aqueous solution.

Before forming the creamy slurry of the carbon powder and the aqueous solution in step i) a water-soluble non-organic compounds are added to aqueous solution to modify the chemical-physical properties of high-density carbon electrode.

In step c) the blended dry precursor is compounded by high-shear treatment and thereafter the carbon-polymer composite is milled to the carbon-polymer granulated powder.

In step d) the high-density carbon sheet is formed from the carbon-polymer granulated powder.

A non-soluble polymeric binding material is a polymeric fluoroalkyl compound or contains at least one fluorinated polymer or said polymeric binding material is polytetrafluoroethylene.

The carbon powder consists of at least 70% of porous disordered carbon which for example is activated carbon or carbide-derived carbon.

By high-shear treatment is achieved a simultaneous fibrillation and compaction of the carbon-polymer composite granulated powder.

A high-density carbon electrodes made from the high-density carbon material manufactured according to the present method described above.

The high-density carbon electrode has density of the carbon-polymer composite film more than 0.67 g/cm³.

The high-density electrodes can be used in energy storage devices, such as ultracapacitors or hybrid capacitors.

Following examples explain in more details the inventive matter. However, it should be understood that this invention is certainly not limited by these examples.

### EXAMPLE 1

The quantity of aqueous solution free of organic solvents is added to the carbon powder, such that the carbon and an aqueous solution form creamy carbon slurry. The exact amount of the aqueous solution depends on the porosity of carbon powder, but usually is 3 to 1 by weight relative to carbon. In one example, the aqueous solution free of organic solvents may be water (distilled water). In another example, this aqueous solution may comprise an ionic compound used as a component of electrolyte. Yet in the other example the aqueous solution may comprise a various water-soluble compounds used to modify the chemical-physical properties of high-surface carbon electrode.

After that a desired amount of the polymeric fluoroalkyl compound is dispersed in the creamy carbon slurry to form homogeneous slurry of carbon-polymer composite. In one example the fluoroalkyl compound may be polytetrafluoroethylene (PTFE). Yet in another example it may be any completely or partially fluorinated hydrocarbon polymer. The hydrocarbon polymer may be polyethylene (PE), polypropylene (PP), polystyrene (PS), polyacrylonitrile (PAN), polyacrylamide (PAA), RF-resin, polyisobutylene, poly-p-xylylene or ethylene.propylene co-polymers. The amount of PTFE, used to make the carbon-polymer composite, depends on the size of carbon particles and the final thickness of carbon tape, but usually ranges from 4% wt to 12% wt relative to the sum of dry components of carbon/PTFE composite.

In next step, the water is evaporated from a cake-like mixture of carbon powder and PTFE, that can be made at normal pressure at a temperature of 120-140° C. in extensively ventilated drying hood. After that the dried cake of carbon powder and PTFE is milled in the nondestructive milling mixer into the granules. The non-destructive milling, here, means that no knives can be used for milling, which could course the damage to polymer chains created in carbon agglomerates during pre-compaction treatment.

Then, in next step, the carbon/PTFE granules can be directly rolled into the thin carbon tape by using single or multi-step calendering. In another example, the carbon/PTFE powder is firstly extruded into the thick raw tape, wherein the extrusion, for example, can be done by using a roll-press equipped with a feeder for inserting the carbon/PTFE powder. In one example, the thickness of raw type may vary in between 200-400 micrometers.

In final stage the carbon/PTFE tape is compacted by calendering to reach the desired tape thickness that, for example, can be any thickness in between 30 to 200 micrometers.

### EXAMPLE 2

Polarisable carbon electrodes were prepared as follows. The pre-compacted mixture of 87% (wt.) microporous carbon (YP-50F, Kuraray), 3% (wt.) carbon black (Super C60, Timcal) and 10% (wt.) polytetrafluoroethylene (PTFE, Aldrich, 60% suspension in water) was prepared according to the method of example 1 and rolled stepwise into the carbon film with a final thickness of 60 μm. The density of 0.74 g/cm3 was reached.

### EXAMPLE 3

### High Shear Compounding Process.

An amount of carbon electrode material prepared according to the method of example 1 was inserted into the high shear compounder. The compounder was equipped with a torque measuring device. The electrode material mixture was mixed until the mixing torque achieved desired or maximum value (depending on the type of high-shear compounder).

In the next step the resulting material, dense rubber like substance, underwent the non-destructive granulation/milling process to the size of 10-1000 mkm, depending on final electrode thickness required. Each individual granule retains the pre-compacted material density—hence less force is required for calendering process.

Examples collected in Table 2 present the major characteristics of carbon electrodes achieved according to this invention from the pre-compacted carbon/binder composite granules preliminary treated in high-shear compounder.

Table 1. Characteristics of the electrodes made with variable thicknesses from 3 different electrode compositions (No. 1-3).

TABLE 1

| Electrode | | Geometric | | | | Thick- |
|---|---|---|---|---|---|---|
| Com- | Electrode | density | BET | V(micro) | V(total) | ness |
| position | No. | g/cm3 | m2/g | cm3/g | cm3/g | mkm |
| | 1#1 | 0.81 | 1126 | 0.46 | 0.55 | 62 |
| 90% | 1#2 | 0.80 | | | | 58-59 |
| AC1 + 10% | | | | | | |
| PTFE | | | | | | |
| | 1#3 | 0.80 | | | | 65-66 |
| 90% | 2#1 | 0.79 | 1064 | 0.44 | 0.52 | 58-59 |
| AC1/AC2 | | | | | | |
| (3/2) + 10% | | | | | | |
| PTFE | | | | | | |
| | 2#2 | 0.79 | | | | 67-68 |
| 87% | 3#1 | 0.67 | 1219 | 0.49 | 0.61 | 65 |
| AC2 + 3% | | | | | | |
| CB + 10% | | | | | | |
| PTFE | | | | | | |
| | 3#2 | 0.67 | | | | 58-59 |

AC1 and AC2—activated carbons,
CB—carbon black,
PTFE—polytetrafluoroethylene

High-shear treatment during pre-compaction of the carbon-PTFE mixture enables to reduce the relative quantity of the binding material (Table 2) required for efficient binding of the carbon particles in the electrode that is beneficial for increasing the quantity of active materials (i.e. porous carbon) in the predetermined volume of the energy storage cell.

Table 2. Comparison of the densities achievable with different quantities of binding material in the pre-compacted electrode material made according to this invention.

TABLE 2

| | | Bulk density of | | |
|---|---|---|---|---|
| | | the compacted | | |
| | Composition | high-shear | experimental | experimental |
| Sample | of the electrode | treated electrode | body | body |
| No | mixture | material, g/cm3 | mass (g) | hight (cm) |
| #9 | 87% AC2 + 3% | 0.664 | 0.53732 | 0.74 |
| | CB + 10% PTFE | | | |
| #16 | 92% AC2 + 3% | 0.657 | 0.53245 | 0.741 |
| | CB + 5% PTFE | | | |

1) A method for making a high-density carbon material for high-density carbon electrodes by wet process free of organic solvents, the method comprising the steps of:
a) pre-compaction of carbon/polymer composite in wet process where
i) applying an aqueous solution free of organic solvents to the carbon powder to form a creamy slurry of the carbon powder and an aqueous solution in which the nanopores of carbon powder are not penetrated by aqueous solution,
ii) dispersing a non-soluble polymeric binding material into the creamy slurry of the carbon powder and the aqueous solution to form homogeneous mixture of carbon-polymer composite in the form of slurry;
b) making a dry precursor from pre-compacted carbon/polymer composite in the form of slurry by evaporating aqueous solution from said carbon-polymer composite slurry,
c) milling in non-destructive way a blended dry precursor thereafter into a carbon-polymer composite granulated powder and thereafter forming a carbon-polymer composite film from said carbon-polymer composite granulated powder.

2) The method according to claim 1 wherein in step a) i) before forming the creamy slurry of the carbon powder and the aqueous solution an ionic compound as a component of electrolyte is added to the aqueous solution.

3) The method according to claim 1 wherein in step i) before forming the creamy slurry of the carbon powder and the aqueous solution a water-soluble non-organic compounds are added to aqueous solution to modify the chemical-physical properties of high-density carbon electrode.

4) The method according to claim 1 wherein in step c) the blended dry precursor is compounded by high-shear treatment and thereafter the carbon-polymer composite is milled to the carbon-polymer granulated powder.

5) The method according to the claim 1 wherein in step d) the high-density carbon sheet is formed from the carbon-polymer granulated powder.

6) The method according to claim 1 wherein a non-soluble polymeric binding material is a polymeric fluoroalkyl compound.

7) The method according to claim 1, wherein the non-soluble polymeric binding material contains at least one fluorinated polymer.

8) The method according to claim 1, wherein the polymeric binding material is polytetrafluoroethylene.

9) The method according to claim 1, wherein the carbon powder consists of at least 70% of porous disordered carbon.

10) The method according to claim 9, wherein the porous disordered carbon is activated carbon.

11) The method according to claim 9, wherein the porous disordered carbon is carbide-derived carbon.

12) The method according to claim 4, wherein by high-shear treatment is achieved a simultaneous fibrillation and compaction of the carbon-polymer composite granulated powder.

13) A high-density carbon electrodes made from the high-density carbon material manufactured according to the method of claims 1-12.

14) The high-density carbon electrode according to claim 13 wherein the density of the carbon-polymer composite film is more than 0.67 g/cm³.

15) Use of the high-density electrodes according to claim 13 in energy storage devices, such as ultracapacitors or hybrid capacitors.
